(19) United States
(12) Patent Application Publication
(10) Pub. No.: US 2008/0198109 A1
(43) Pub. Date: Aug. 21, 2008

(54) COLOR MAGNETIC DISPLAY PIXEL PANEL

(75) Inventor: Sung Nae Cho, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/031,728

(22) Filed: Feb. 15, 2008

(30) Foreign Application Priority Data
Feb. 16, 2007 (KR) 10-2007-0016783
May 11, 2007 (KR) 10-2007-0046199
Sep. 18, 2007 (KR) 10-2007-0094778

(51) Int. Cl. G09G 3/36

(52) U.S. Cl. 345/87

(57) ABSTRACT

A magnetic display panel having pixels formed of red, green, blue, and black sub-pixels. Each of the sub-pixel includes a magnetic material layer in which magnetic moments are oriented in a direction when a magnetic field is applied, a sub-pixel electrode applying a magnetic field to the magnetic material layer, a common electrode electrically connected to the sub-pixel electrode, and a control circuit switching the flow of current between the sub-pixel electrode and the common electrode.

### CROSS-REFERENCE TO RELATED PATENT APPLICATIONS

This application claims the benefit of Korean Patent Application No. 10-2007-0016783, filed on Feb. 16, 2007, No. 10-2007-0046199, filed on May 11, 2007, and No. 10-200-0094778, filed on Sep. 18, 2007, in the Korean Intellectual Property Office, the disclosures of which are incorporated herein in their entireties by reference.

### BACKGROUND OF THE INVENTION

1. Field of the Invention

Apparatuses consistent with the present invention relate to a color magnetic display panel, and more particularly, to a color magnetic display panel including an optical shutter formed of a magnetic material layer.

2. Description of the Related Art

Recently, LCD (liquid crystal display) panels and PDPs (plasma display panels) are mainly used as flat display panels. Also, OLEDs (organic light emitting diodes) have been studied to be used as the next generation of flat display panels.

Since the LCD panel is not a non-emissive type, an optical shutter for transmitting/blocking light emitted from a backlight unit or external light is needed. The optical shutter for the LCD panel consists of two polarization panels and a liquid crystal layer arranged between the two polarization panels. Of the two polarization panels, a polarization panel near a light source is referred to a polarizer and a polarization panel at the opposite side is referred to as an analyzer. The polarizing axes of the polarizer and the analyzer make an angle of 90°. The liquid crystal layer only rotates polarized light.

In this structure, when unpolarized light emitted from a backlight unit (BLU) passes through the polarizer, a light polarized in one direction is selected and arrives at the analyzer after passing through the liquid crystal layer. Whether the light having passed through the polarizer passes through the analyzer or not is determined by the amount of rotation of the polarized light by the liquid crystal layer. Since the polarizing axes of the polarizer and the analyzer make an angle of 90°, when the liquid crystal rotates the polarized light at any degree, light corresponding to the amount of rotation passes through the analyzer. Also, when the liquid crystal does not rotate the light at all, the light cannot pass through the analyzer.

One of the important issues in the case of the LCD is securing a wide viewing angle. In this regard, liquid crystals used to solve this issue have a disadvantage in that manufacturing costs are high. Thus, studies to secure a wide viewing angle in a low cost liquid crystal are being performed. Also, the existing LCD has a problem of motion blur due to a low response time.

The PDP that is an emissive type dose not require an optical shutter, but has problems in that power consumption is high and a large amount of heat is generated. Also, the OLED that is an emissive type does not require an optical shutter. The OLED is under development and has problems in that manufacturing costs are high and life span is relatively short.

### SUMMARY OF THE INVENTION

The present invention provides a color magnetic display panel having an optical shutter using a magnetic material not liquid crystal.

The present invention provides an electronic device including the above color magnetic display panel.

According to an aspect of the present invention, a magnetic display panel having pixels formed of red, green, blue, and black sub-pixels, wherein each of the sub-pixel comprises a magnetic material layer in which magnetic moments are oriented in one direction when an magnetic field is applied, a sub-pixel electrode applying a magnetic field to the magnetic material layer, a common electrode electrically connected to the sub-pixel electrode, and a control circuit switching the flow of current between the sub-pixel electrode and the common electrode.

A light of a magnetic field component parallel to the direction in which the magnetic moments in the magnetic material layer are oriented is reflected from the magnetic material layer, and a light of a magnetic field component perpendicular to the direction passes through the magnetic material layer.

The thickness of the magnetic material layer is greater than the magnetic decay length of the magnetic material layer.

The magnetic material layer has a structure in which a plurality of magnetic particles are distributed in a transparent insulation medium, and each of the magnetic particles includes a magnetic core having a transparent insulation shell encompassing the magnetic core.

One magnetic core forms a single magnetic domain.

The magnetic core is formed of ferromagnetic, a paramagnetic material or a superparamagnetic material.

The magnetic core is formed of one of materials selected from a group consisting of cobalt, iron, iron oxide, nickel, a Co—Pt alloy, a Fe—Pt alloy, titanium, aluminum, barium, platinum, sodium, strontium, magnesium, dysprosium, manganese, and gadolinium, silver, copper, and chromium, or an alloy thereof.

The magnetic material layer is formed of a magnetic polymer film having conductivity.

The sub-pixel further comprises a conductive spacer which is arranged at a side surface of the magnetic material layer and electrically connects the sub-pixel electrode and the common electrode.

The common electrode is a flat sheet or a lattice type wire electrically connected to the conductive spacer.

The sub-pixel electrode, the common electrode, and the conductive spacer are formed of any of materials selected from a group consisting of aluminum, copper, silver, platinum, gold, barium, sodium, strontium, magnesium, and iodine-doped polyacetylene.

A first hole is formed in an area of the sub-pixel electrode facing the magnetic material layer and a plurality of wires extending in a direction in which current flows are formed in the first hole to allow light to pass through the sub-pixel electrode.

A second hole is formed in an area of the common electrode facing the magnetic material layer to allow light to pass through the common electrode.

The sub-pixel electrode and the common electrode are formed of a transparent conductive material.

Each of the sub-pixels further comprises a color filter and color filters of red, green, and blue sub-pixels are arranged above or under the magnetic material layer and a color filter of a black sub-pixel is arranged under the magnetic material layer.

Each of the sub-pixels further comprises a rear transparent substrate and a front transparent substrate respectively arranged at the rear surface and the front surface of the magnetic display panel to encompass the rear and front surfaces of the sub-pixels.

Each of the sub-pixels further comprises an absorption polarizer arranged on any of optical surfaces from the magnetic material layer to an external surface of the front transparent substrate.

Each of the sub-pixels further comprises an antireflection coating arranged on at least one of optical surfaces from the magnetic material layer to an external surface of the front transparent substrate.

The rear transparent substrate, the front transparent substrate, and the common electrode are shared by all pixels and the magnetic material layer, the sub-pixel electrode, the color filter, and the control circuit are respectively provided one for each of the sub-pixels.

Each of the sub-pixels further comprises a reflection plate arranged on at least one of optical surfaces from the lower portion of the color filter to an external surface of the rear transparent substrate.

The reflection plate is an array of hybrid curved surfaces in which two types of curved surface are combined, a center portion of the hybrid curved surface is a convex parabolic surface having a symmetry axis at the center thereof, and an outer circumferential portion surrounding the center portion of the hybrid curved surface is a concave parabolic surface extending from the center portion and having a focus at the symmetry axis of the center portion.

Pigments or color absorption particles mixed in the magnetic material layer.

Each of the color absorption particles is formed of a core formed of a dielectric and a shell formed of metal.

### BRIEF DESCRIPTION OF THE DRAWINGS

The above and other features of the present invention will become more apparent by describing in detail exemplary embodiments thereof with reference to the attached drawings in which:

FIG. 1 is a cross-sectional view showing the structure of a sub-pixel of a color magnetic display panel according to an exemplary embodiment of the present invention;

FIG. 2 is a perspective view showing the structures of the sub-pixel electrode, the conductive spacer, and the common electrode of the sub-pixel of the color magnetic display panel of FIG. 1;

FIG. 3 is a perspective view showing the sub-pixel arrangement and the structure of a common electrode of a color magnetic display panel according to an exemplary embodiment of the present invention;

FIG. 4 is a perspective view showing the sub-pixel arrangement and the structure of a common electrode of a color magnetic display panel according to another exemplary embodiment of the present invention;

FIG. 5 is a perspective view showing the sub-pixel arrangement and the structure of a common electrode of a color magnetic display panel according to another exemplary embodiment of the present invention;

FIG. 6 illustrating the structure of a magnetic material layer of a sub-pixel of the color magnetic display panel of FIG. 1;

FIG. 7 is a cross-sectional view of the magnetic material layer of FIG. 6;

FIG. 8 illustrates the structure of a magnetic particle used for the magnetic material layer of FIG. 6;

FIG. 9 illustrates the structure of another magnetic particle used for the magnetic material layer of FIG. 6;

FIG. 10 illustrates the orientations of the magnetic moments in the magnetic material layer when an magnetic field is not applied;

FIG. 11 illustrates the orientations of the magnetic moments in the magnetic material layer when an magnetic field is applied;

FIGS. 12 and 13 are graphs showing the transmission of a magnetic field in the magnetic material layer;

FIG. 14 is a graph showing the transmission ratio of polarization parallel to the polarization perpendicular to the magnetization direction in the magnetic material layer;

FIG. 15 is a cross-sectional view showing an operation when a sub-pixel of the color magnetic display panel according to the present invention is in an OFF state;

FIG. 16 is a cross-sectional view showing an operation when a sub-pixel of the color magnetic display panel according to the present invention is in an ON state;

FIGS. 17 through 22 illustrate examples of implementing a color using sub-pixels, each having red, green, blue, and black colors, in the color magnetic display panel according to an exemplary embodiment of the present invention;

FIGS. 23 through 25 illustrate examples of implementing a color using sub-pixels, each having red, green, blue, and black colors, in a color magnetic display panel according to another exemplary embodiment of the present invention;

FIG. 26 illustrates the structure of a magnetic material layer according to another exemplary embodiment of the present invention;

FIG. 27 is a cross-sectional view showing the structure of a magnetic material layer according to another exemplary embodiment of the present invention using the magnetic material layer of FIG. 26

FIG. 28 is a plan view of a reflection plate in an exemplary embodiment of the invention; and

FIG. 29 shows a common electrode of a mesh or lattice type wire in an exemplary embodiment of the invention.

### DETAILED DESCRIPTION OF THE INVENTION

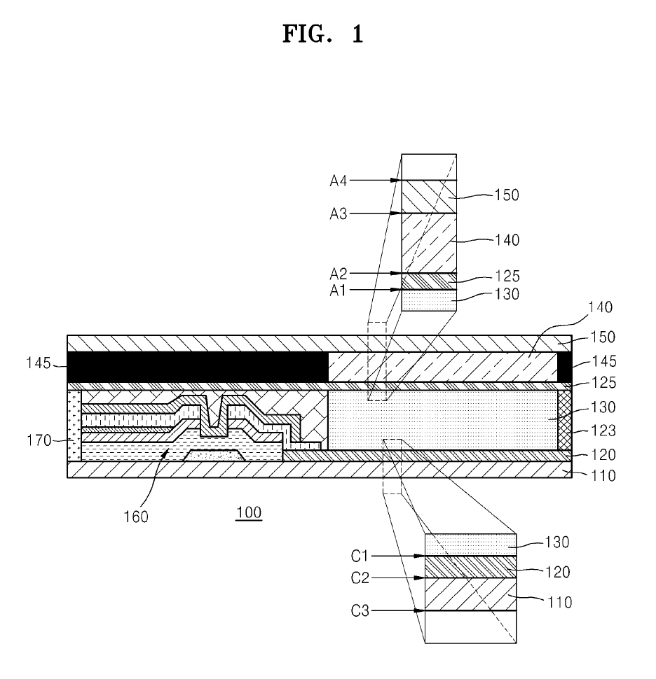

FIG. 1 is a cross-sectional view showing the structure of a sub-pixel of a color magnetic display panel according to an exemplary embodiment of the present invention. Referring to FIG. 1, a sub-pixel 100 of a color magnetic display panel according to an exemplary embodiment of the present invention includes rear and front transparent substrates 110 and 150 arranged to face each other, a magnetic material layer 130 filling a space between the rear and front transparent substrates 110 and 150, a sub-pixel electrode 120 partially formed on the inner surface of the rear transparent substrate 110, a color filter 140 arranged on the inner surface of the front transparent substrate 150, a common electrode 125 arranged on the surface of the color filter 140, and a conductive spacer 123 arranged at a side surface of the magnetic material layer 130, sealing the magnetic material layer 130, and electrically connecting the sub-pixel electrode 120 and the common electrode 125. The rear and front transparent substrates 110 and 150 and the common electrode 125 are shared by all pixels 100. Although FIG. 1 illustrates that the common electrode 125 is arranged on the surface of the color filter 140 and the sub-pixel electrode 120 is arranged on the inner surface of the rear transparent substrate 110, the positions of the sub-pixel electrode 120 and the common electrode 125 can be reversed.

A control circuit 160 for controlling or switching the flow of current between the sub-pixel electrode 120 and the common electrode 125 is formed close to the magnetic material layer 130 on the inner surface of the rear transparent substrate 110. For example, a thin film transistor (TFT) that is typically used in the LCD panel can be directly used as the control circuit 160. When the TFT is used, for example, when a voltage is applied to a gate electrode of the TFT, the TFT is turned on so that current flows between the sub-pixel electrode 120 and the common electrode 125.

Also, a partition wall 170 is vertically formed along the edge of the sub-pixel 100 between the common electrode 125 and the rear transparent substrate 110. The partition wall 170 completely seals the space between the rear and front transparent substrates 110 and 150 with the conductive spacer 123.

A black matrix 145 is formed in an area corresponding to the control circuit 160, the partition wall 170, and the conductive spacer 123 between the common electrode 125 and the front transparent substrate 150. The black matrix 145 hides the control circuit 100, the partition wall 170, and the conductive spacer 123 so as not to be seen from the outside. Although FIG. 1 illustrates that the black matrix 145 and the color filter 140 are arranged between the common electrode 125 and the front transparent substrate 150, they can be arranged on the outer surface of the front transparent substrate 150.

Although it is not shown in FIG. 1, to prevent eye glare due to the reflection and scattering of an external light, an antireflection coating can be formed on at least one of optical surfaces from the magnetic material layer 130 to the front transparent substrate 150. For example, referring to the upper enlarged portion of FIG. 1, the antireflection coating can be formed on at least one of a surface A1 between the magnetic material layer 130 and the common electrode 125, a surface A2 between the common electrode 125 and the color filter 140, a surface A3 between the color filter 140 and the front transparent substrate 150, and an upper surface A4 of the front transparent substrate 150. An absorptive polarizer for absorbing only light polarized in a particular direction can be arranged instead of the antireflection coating.

Also, to appropriately reuse the external light passing through the magnetic material layer 130, a mirror or a semitransparent mirror can be formed on at least one of the optical surfaces from the magnetic material layer 130 to the rear transparent substrate 110. For example, referring to the lower enlarged portion of FIG. 1, a mirror or a semitransparent mirror can be formed on at least one of a surface C1 between the magnetic material layer 130 and the sub-pixel electrode 120, a surface C2 between the sub-pixel electrode 120 and the rear transparent substrate 110, and a lower surface C3 of the rear transparent substrate 110. When a mirror is formed on the entire surface, the color magnetic display panel according to the present invention can use only the external light for display. When a mirror or a semitransparent mirror is formed only on a part of the surface, the external light and the light from the backlight unit all can be used for display.

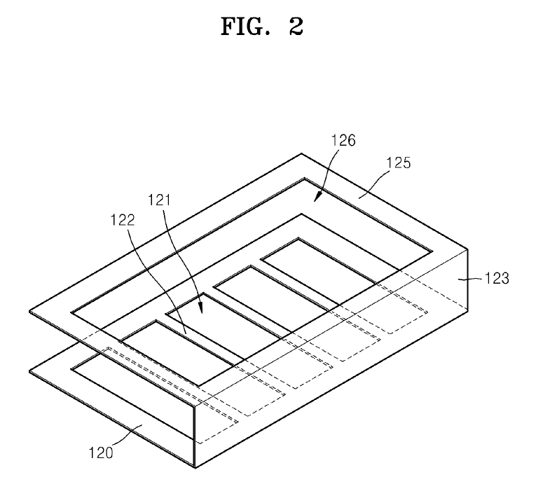

FIG. 2 is a perspective view showing the structures of the sub-pixel electrode 120, the conductive spacer 123, and the common electrode 125 of the sub-pixel 100 of the color magnetic display panel of FIG. 1. Referring to FIG. 2, the sub-pixel electrode 120 corresponds to the lower surface of the magnetic material layer 130 of FIG. 1. The common electrode 125 corresponds to the upper surface of the magnetic material layer 130. The conductive spacer 123 is arranged at one side of the magnetic material layer 130 to electrically connect the sub-pixel electrode 120 and the common electrode 125.

The sub-pixel electrode 120, the conductive spacer 123, and the common electrode 125 are formed of, for example, an opaque metal having low resistivity such as aluminum (Al), copper (Cu), silver (Ag), platinum (Pt), gold (Au), barium (Ba), chrome (Cr), sodium (Na), strontium (Sr), and magnesium (Mg). Also, in addition to the metal, conductive polymer such as iodine-doped polyacetylene can be used as a material for the sub-pixel electrode 120, the conductive spacer 123, and the common electrode 125.

When the opaque material is used, so that the light passes through the sub-pixel electrode 120 and the common electrode 125, as shown in FIG. 2, holes 121 and 126 are respectively formed in the sub-pixel electrode 120 and the common electrode 125 in an area corresponding to the magnetic material layer 130. A plurality of small holes 121 are formed in the sub-pixel electrode 120 parallel to one another and a plurality of wires 122 extending in a direction in which current flows are left between the holes 121 in order to easily apply a magnetic filed to the magnetic material layer 130. In contrast, a relatively large hole 126 having a size almost the same as that of the magnetic material layer 130 can be formed in the common electrode 125.

When current is applied to the wires 122, magnetic fields in the space between the wires 122 offset each other and do not exist. Also, a more parallel and uniform magnetic field is formed far from the wires 122. Thus, it is preferable, but not necessary, that the magnetic material layer 130 does not intrude into a space between the wires 132. Also, the magnetic material layer 130 is preferably, but not necessarily, separated a predetermined distance from the wires 122. To this end, the hole 121 formed between the wires 122 of the sub-pixel electrode 120 and the hole 126 of the common electrode 125 is further filled with a light transmissive material. A light transmissive material having a predetermined thickness can be provided on a boundary surface between the sub-pixel electrode 120 and the magnetic material layer 130 and a boundary surface between the common electrode 125 and the magnetic material layer 130. Accordingly, a uniform magnetic field can be applied to the whole area of the magnetic material layer 130. Also, the intrusion of the magnetic material layer 130 into an area where a magnetic field is weak or hardly exists can be prevented.

However, a conductive material that is transparent to visible rays, such as ITO, can be used for the sub-pixel electrode 120 and the common electrode 125. In this case, there is no need to separately form a hole in the sub-pixel electrode 120 and the common electrode 125. Also, a technology to coat a metal very thinly to a thickness of several nanometers or less has been recently developed. Thus, when a conductive metal is formed to have a thickness less than a skin depth of the metal, light can be transmitted therethrough. Thus, the sub-pixel electrode 120 and the common electrode 125 can be formed by thinly coating the conductive metal to a thickness less than the skin depth thereof.

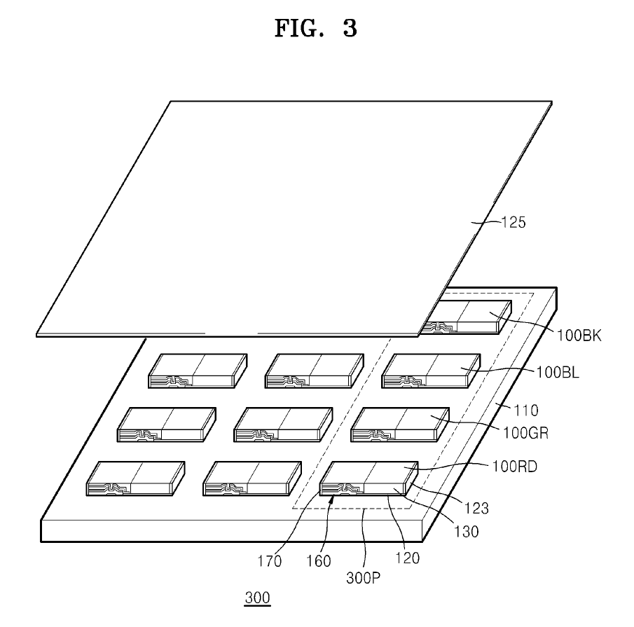

FIGS. 3-5 illustrate the arrangement of the sub-pixels 100 and the various structures of the common electrode 125, which is common to the sub-pixels 100 in the color magnetic display panel 300 according to the present invention.

Referring first to FIG. 3, the color magnetic display panel 300 according to the present exemplary embodiment includes a plurality of sub-pixels arranged two-dimensionally on a single common rear transparent substrate 110. The sub-pixels, each having a different color filter, form a pixel. For example, as shown in FIG. 3, a sub-pixel 100RD having a red color filter, a sub-pixel 100GR having a green color filter, a sub-pixel 100BL having a blue color filter, and a sub-pixel 100BK having a black color filter form a single pixel 300P.

The sub-pixels 100 of the color magnetic display panel 300 according to the present exemplary embodiment include the single common electrode 125. In FIG. 3, the common electrode 125 is a transparent electrode formed of a transparent conductive material such as ITO. In this case, there is no need to form a hole for transmitting light in the common electrode 125. In the structure, only when the control circuit 160 arranged at each sub-pixel 100 is turned on, current flows from the common electrode 125 to the sub-pixel electrode 120 of a corresponding sub-pixel via the spacer 123. While the current flows through a very large area in the common electrode 125, the current flows through a very small area in the sub-pixel electrode 120 so that the current density of the sub-pixel electrode 120 is much greater than that of the common electrode 125. Thus, the magnetic material layer 130 is affected only by the sub-pixel electrode 120 and hardly affected by the common electrode 125.

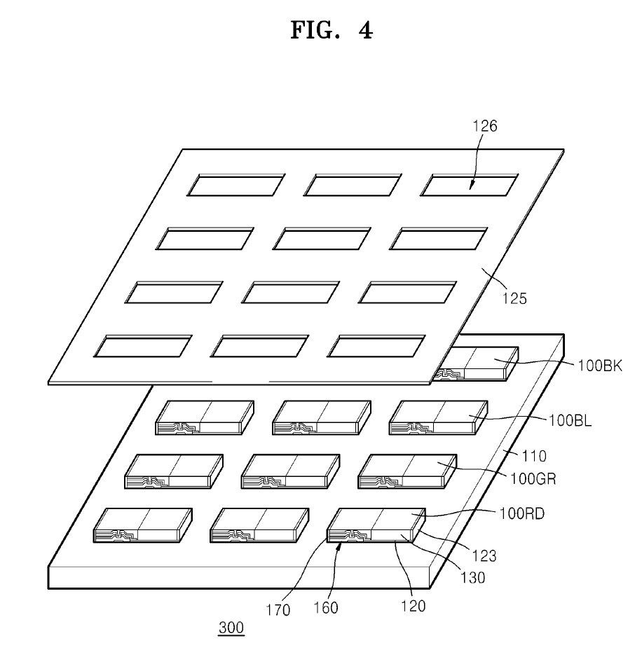

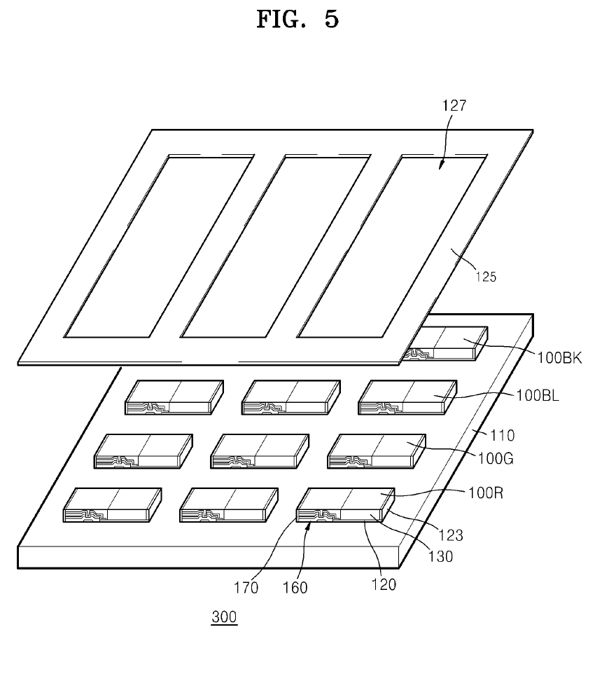

FIGS. 4 and 5 illustrate a case where the common electrode 125 is formed of an opaque metal or conductive polymer. In FIG. 4, the hole 126 for light transmission is formed in the common electrode 125 at a position corresponding to each sub-pixel 100 as shown in FIG. 2. In FIG. 5, a hole 127 for light transmission that is relatively larger than the hole 126 is formed in the common electrode 125 at a position corresponding to a pixel formed of four sub-pixels 100.

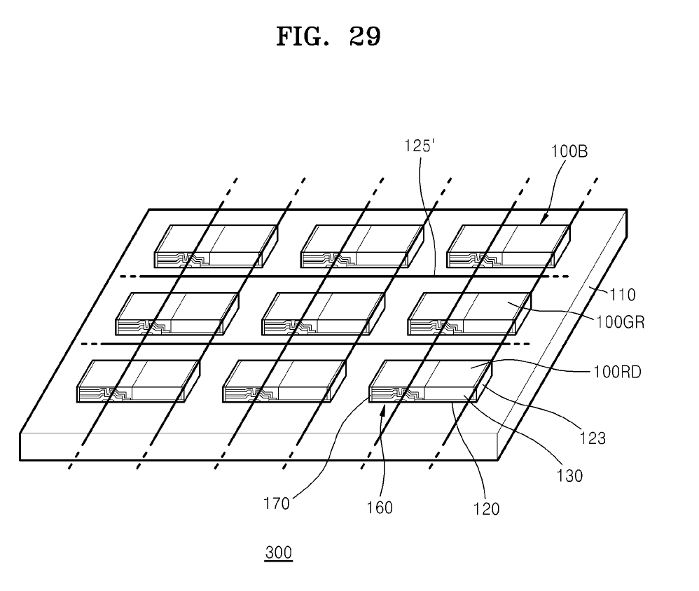

However, according to the present invention, the structure of the common electrode 125 is not limited to the shapes shown in FIGS. 3-5. Although FIGS. 3-5 illustrate that the common electrode 125 is a flat sheet, for example, a mesh or lattice type wire 125′ can be employed, as shown in FIG. 29. That is, it is sufficient that the common electrode 125 regardless of its shape is electrically connected to the conductive spacer 123 of each sub-pixel. Also, although FIGS. 3-5 illustrate that the common electrode 125 and the sub-pixel electrode are provided on different substrates, the common electrode 125 and the sub-pixel electrode 120 formed of the wire in a mesh or lattice structure can be formed on the same substrate.

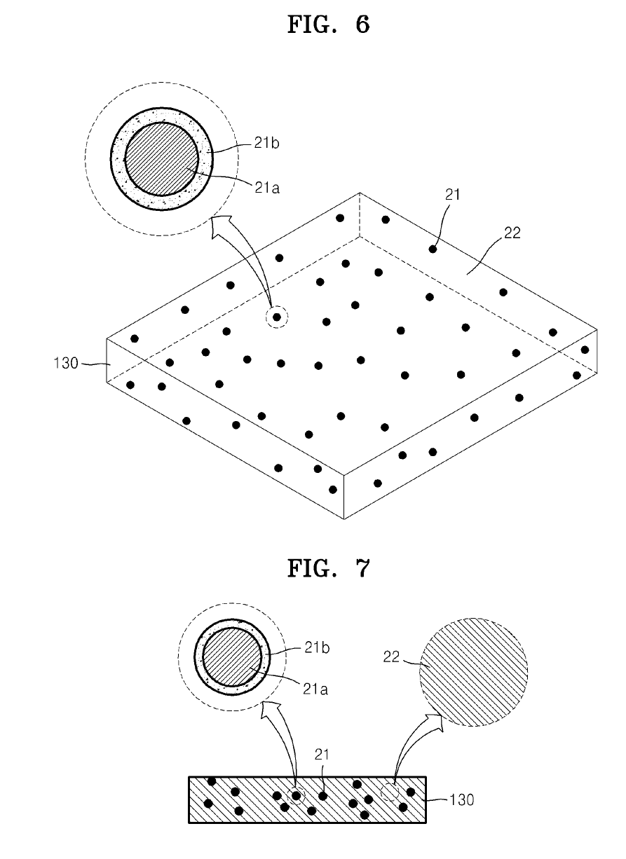

FIG. 6 illustrates the structure of the magnetic material layer 130 according to the present invention. FIG. 7 is a cross-sectional view of the magnetic material layer 130 of FIG. 6. Referring to FIGS. 6 and 7, the magnetic material layer 130 has a structure in which a plurality of magnetic particles 21, each having a magnetic core, are distributed in a transparent insulation material 22 such that the magnetic particles 21 are not agglomerated together or electrically contacting one another. In FIGS. 6 and 7, for convenience of explanation, the magnetic particles 21 are sparsely distributed in the magnetic material layer 130. However, in an exemplary embodiment, the magnetic particles 21 are densely distributed in the magnetic material layer 130. To prevent the magnetic particles 21, having magnetic cores, from being agglomerated together or electrically contacting one another, each of the magnetic particles 21 is formed of a magnetic core 21a having an insulation shell 21b that is transparent and non-magnetic and encompasses the magnetic core 21a. A space between the magnetic particles 21 can be filled with a transparent, non-magnetic, insulating dielectric material like the insulation shell 21b.

The magnetic material layer 130 can be formed by, for example, mixing the magnetic cores 21a with a transparent insulation material in a paste state and thinly coating the mixture on the sub-pixel electrode 120, and then, curing the coated mixture. Also, the magnetic material layer 130 can be formed by immersing the magnetic particles 21 having a core-shell structure in a solution and performing spin coating or deep coating of the solution thinly on the sub-pixel electrode 120, and then, curing the coated solution. Furthermore, the magnetic material layer 130 can be formed by directly attaching a conductive magnetic polymer film to the sub-pixel electrode 120. The conductive magnetic polymer film that has been recently developed to have a magnetic characteristic. In this case, the magnetic polymer film has a thickness of, for example, 100 nm or less, so as to be operated in the same manner as the magnetic core with a single domain. Also, the magnetic material layer 130 can be formed by immersing a mixture of a magnetic core and an insulating transparent non-magnetic core in a solution and performing spin coating or deep coating of the solution thinly on the sub-pixel electrode 120, and then, curing the coated solution. Other methods can be employed as long as the magnetic particles 21 are not combined together or electrically contact one another.

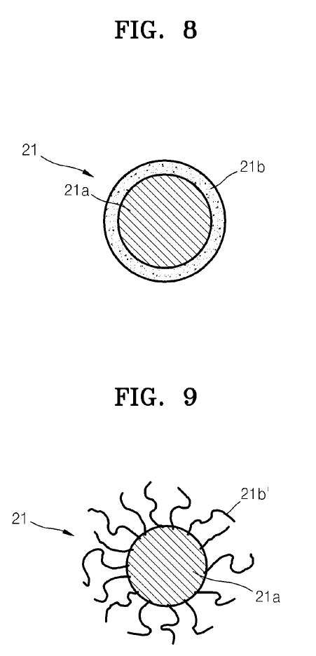

FIGS. 8 and 9 illustrate the core-shell structures of the magnetic particles 21 forming the magnetic material layer 130. As shown in FIGS. 8 and 9, the magnetic particles 21 can be formed of the magnetic core 21a that is formed of a magnetic material, and insulation shells 21b or 21b′ encompassing the magnetic core 21a. Any material among ferromagnetic, paramagnetic, and superparamagnetic materials, only if having characteristics as a magnetic substance, can be used for the magnetic core 21a of the magnetic particles 21. For example, a paramagnetic metal or alloy such as titanium, aluminum, barium, platinum, sodium, strontium, magnesium, dysprosium, manganese, and gadolinium, or a diamagnetic metal or alloy such as silver or copper can be used for the magnetic core 21a. Also, an anti-ferromagnetic metal such as chromium, which is able to change to a paramagnetic substance at a temperature above the Neel temperature, can be used for the magnetic core 21a. Furthermore, a ferromagnetic metal, such as cobalt, iron, nickel, or an alloy including any of the ferromagnetic metals, or an alloy thereof, for example Co—Pt alloy, Fe—Pt alloy, can be used for the magnetic core 21a by providing a super-paramagnetic characteristic. To make the ferrormagnetic substance have the super-paramagnetic characteristic, the volume of the magnetic core 21a may be sufficiently less than that of a single magnetic domain. In addition to metals, a material such as a dielectric, a semiconductor, or a polymer can be used for the magnetic core 21a only if it has the characteristics as a magnetic substance. Also, a ferrimagnetic substance exhibiting a low conductivity, but a very high magnetic susceptibility, for example, iron oxides such as MnZn(Fe₂O₄)₂, MnFe₂O₄, Fe₃O₄, and Fe₂O₃, and Sr₈CaRe₃Cu₄O₂₄, can be used for the magnetic core 21a.

The diameter of the magnetic core 21a may be sufficiently small such that a single unit of the magnetic core 21a can form a single magnetic domain. Thus, the diameter of the magnetic core 21a of the magnetic particles 21 may be several nanometers to tens of nanometers according to the material in use. For example, the diameter of the magnetic core 21a can vary from about 1 nm through 200 nm according to the material in use.

The insulation shells 21b and 21b′ prevent the magnetic cores 21a adjacent to each other from being agglomerated together or directly contacting one another so as to avoid an electric contact between the magnetic cores 21a. For this purpose, as shown in FIG. 8, the insulation shell 21b, formed of a non-magnetic, transparent, and insulating dielectric material, for example, SiO₂ or ZrO₂, encompasses the magnetic core 21a. Also, as shown in FIG. 9, the insulation shell 21b′, formed of a surfactant in a polymer state, encompasses the magnetic core 21a. The polymer type surfactant may be transparent and exhibit insulation and non-magnetic characteristics. The insulation shells 21b and 21b′ may be sufficiently thick to avoid conduction between the neighboring magnetic cores 21a.

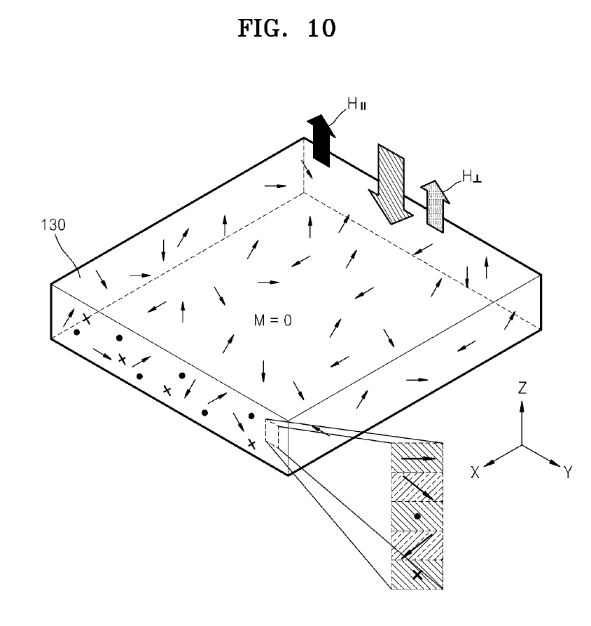

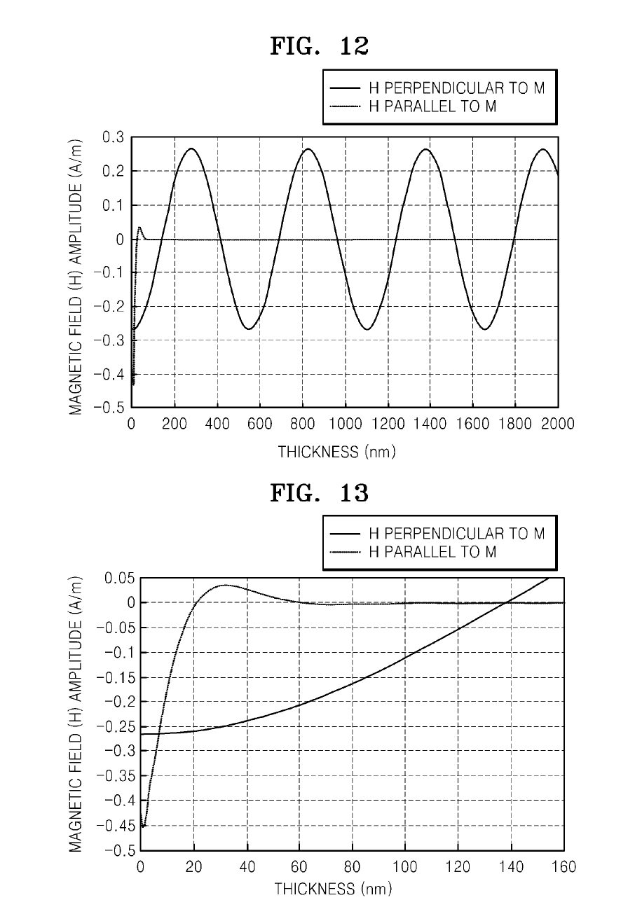

FIG. 10 schematically illustrates the orientation of magnetic moments in the magnetic material layer 130 when a magnetic field is not applied. When a magnetic field is not applied, the overall magnetic moments in the magnetic material layer 130 are randomly oriented in various directions as indicated by the arrows in FIG. 10. In FIG. 10, “.” indicates the magnetic moment in a +x direction on an x-y plane and “x” indicates the magnetic moment in a −x direction on the x-y plane. Also, as shown in an enlarged portion in FIG. 12, the magnetic moments in the magnetic material layer 130 are randomly oriented not only in one direction in the x-y plane, however, but also in a vertical direction, that is, a −z direction. Thus, when the magnetic field is not applied, the total magnetism in the magnetic material layer 130 is 0 (M=0).

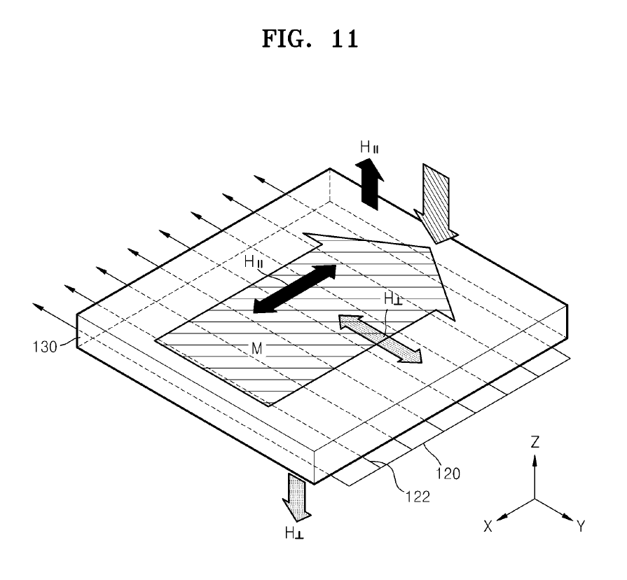

FIG. 11 schematically illustrates the orientation of magnetic moments in the magnetic material layer 130 when a magnetic field is applied. A means for applying a magnetic field to the vicinity of the magnetic material layer 130 is the sub-pixel electrode 120 arranged on the lower surface of the magnetic material layer 130. In particular, when the sub-pixel electrode 120 is formed of an opaque metal, the magnetic field is applied to the vicinity of the magnetic material layer 130 through wires 122 of the sub-pixel electrode 120 extending in a direction in which the currentflows. For example, as shown in FIG. 11, when the current is applied to the sub-pixel electrode 120 so that the current flows in a −y direction along the wires 122, the magnetic material layer 130 is magnetized in the −x direction. That is, the magnetic moments in the magnetic material layer 130 are all oriented in the −x direction.

According to the principle of the transmission and blocking of light in the magnetic material layer 130 having the above-described structure, a magnetic field with an electromagnetic wave incident on the magnetic material layer 130 can be separated into a component H_{⊥} that is perpendicular to the magnetization direction of the magnetic material layer 130 and a component H_{∥} that is parallel to the magnetization direction of the magnetic material layer 130. When the component H_{∥} is incident on the magnetic material layer 130, the component H_{∥} interacts with the magnetic moments oriented in the magnetization direction so that an induced magnetic moment is generated. The induced magnetic moment varies with time as the amplitude of a magnetic field of the component H_{∥} varies with time. As a result, an electromagnetic wave is generated by the time-varying induced magnetic moment according to the general principle of the radiation of an electromagnetic wave. The generated electromagnetic wave can propagate in all directions. However, the electromagnetic wave traveling in the magnetic material layer 130, that is, an electromagnetic wave traveling in a −z direction, is attenuated by the magnetic material layer 130. When the thickness t of the magnetic material layer 130 is larger than a magnetic decay length, which is a concept similar to the skin depth length of an electric field, most of the electromagnetic wave traveling in the magnetic material layer 130 of the electromagnetic waves generated by the induced magnetic moment is attenuated and only an electromagnetic wave traveling in a +z direction is left. Thus, the component H_{∥} can be regarded as being reflected from the magnetic material layer 130

In contrast, when the component H_{⊥} is incident on the magnetic material layer 130, the component H_{⊥} does not interact with the magnetic moment so that no induced magnetic moment is generated. As a result, the component H_{⊥} passes through the magnetic material layer 130 without attenuation.

Consequently, of the magnetic field of the electromagnetic wave incident on the magnetic material layer 130, the component H_{∥} is reflected from the magnetic material layer 130 and the component H_{⊥} passes through the magnetic material layer 130. Thus, light energy (S_{∥}=E_{∥}×H_{∥}) related to the magnetic field of the component H_{∥} is reflected from the magnetic material layer 130 and light energy (S_{⊥}=E_{⊥}×H_{⊥}) related to the magnetic field of the component H_{⊥} passes through the magnetic material layer 130.

In FIG. 10, when the magnetic field is not applied to the magnetic material layer 130, the magnetic moments in the magnetic material layer 130 are randomly oriented not only in the x-y plane but also in a depth direction, that is, the −z direction. Accordingly, the light incident on the magnetic material layer 130 to which the magnetic field is not applied is all reflected. In contrast, as shown in FIG. 11, when the magnetic field is applied to the magnetic material layer 130, the magnetic moments in the magnetic material layer 130 are aligned in a direction. Thus, of the light incident on the magnetic material layer 130, the light having a polarization component related to the component H_{∥} is reflected from the magnetic material layer 130 and the light having a polarization component related to the component H_{⊥} passes through the magnetic material layer 130. In conclusion, the magnetic material layer 130 blocks the light when the magnetic field is not applied and transmits the light when the magnetic field is applied, thus functioning as an optical shutter.

To perform an optical shutter function, the magnetic material layer 130 needs to have a thickness to sufficiently attenuate the electromagnetic wave traveling in the magnetic material layer 130. That is, as described above, the thickness t of the magnetic material layer 130 may be greater than the magnetic decay length of the magnetic material layer 130. In particular, when the magnetic material layer 130 is formed of the magnetic cores distributed in a transparent medium, a sufficient number of the magnetic cores may exist along a path in which the light travels in the magnetic material layer 130. For example, assuming that the magnetic material layer 130 is formed by depositing the same layers on the x-y plane, in which the magnetic cores are uniformly distributed in a single layer, in the z direction, the number n of the magnetic cores needed along the path of the light traveling in the −z direction can be given by the following mathematical expression.

n≧s/d [EQN. 1]

where, “s” is the magnetic decay length of the magnetic core at the wavelength of an incident light and “d” is the diameter of the magnetic core. For example, when the diameter of the magnetic core is 7 nm and the magnetic decay length of the magnetic core at the wavelength of the incident light is 35 nm, five magnetic cores are needed along the path of the light. Thus, when the magnetic material layer 130 is formed of the magnetic cores distributed in a transparent medium, the thickness of the magnetic material layer 130 can be determined such that n or more number of the magnetic cores exist in the thickwise direction of the magnetic material layer 130 in consideration of the density of the magnetic cores.

FIGS. 12-14 show the results of simulations to confirm the characteristic of the magnetic material layer 130. FIG. 12 is a graph showing the intensity (A/m) of a magnetic field that varies according to time and passes through the magnetic material layer 130 when the magnetic field is applied.

FIG. 13 is a graph showing an enlarged portion of FIG. 12. The graphs of FIGS. 12 and 13 show the results of calculation when titanium is used as a material for the magnetic material layer 130 and the wavelength of the incident light is 550 nm. Titanium has a magnetic susceptibility of about 18×10⁻⁵ and an electric conductivity of about 2.38×10⁶ S (Siemens) at a room temperature of 20° C., as it is well known to one skilled in the art. As shown in FIGS. 12 and 13, in case of a magnetic field perpendicular to the magnetization direction of the magnetic material layer 130, even if the thickness of the magnetic material layer 130 is increased, the magnetic field passes through the magnetic material layer 130 without an attenuation loss. In contrast, the amplitude of the light with a magnetic field parallel to the magnetization direction of the magnetic material layer 130 is greatly attenuated to nearly 0 at the wavelength of about 60 nm. Thus, when the titanium is used as a magnetic material of the magnetic material layer 130, it is appropriate that the thickness of the magnetic material layer 130 be about 60 nm.

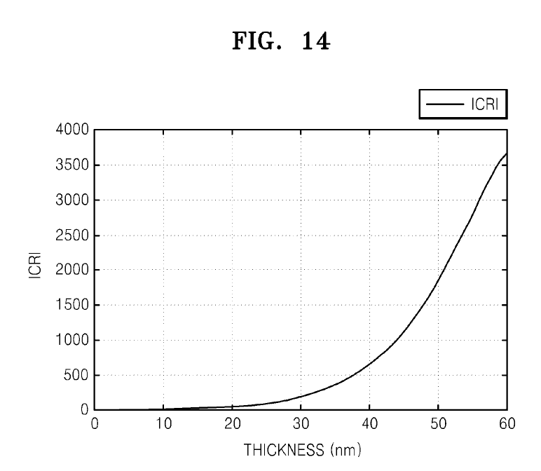

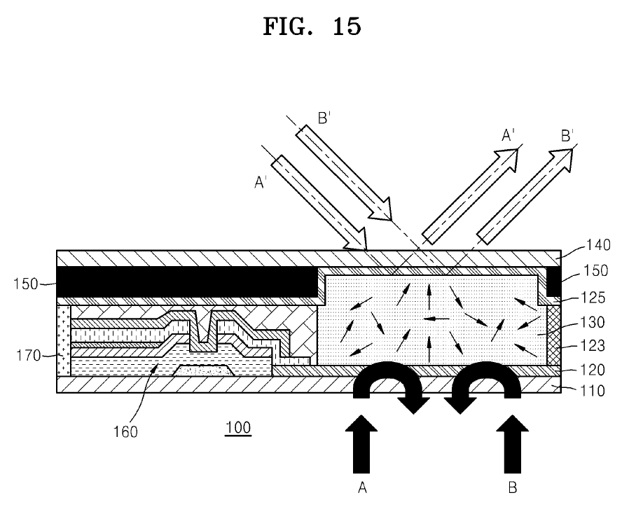

FIG. 14 is a graph showing the absolute value of a contrast ratio (CR) of the magnetic material layer 130, that is, a ratio of transmissivity of the light having a magnetic field perpendicular to the magnetization direction to the transmissivity of the light having a magnetic field parallel to the magnetization direction. For example, when “W1” is a light to be transmitted and “W2” is a light that may not be transmitted, the contrast ratio can be defined as W1/W2. For the magnetic material layer 130, “W1” is S_{⊥}=E_{⊥}×H_{⊥} and “W2” is S_{∥}=E_{∥}×H_{∥}. The graph of FIG. 14 shows that the contrast ratio greatly increases as the thickness of the magnetic material layer 130 increases.

The operation of the sub-pixel 100 of a color magnetic display panel according to an exemplary embodiment of the present invention using the above-described magnetic material layer 130 as an optical shutter is described in detail.

First, FIG. 15 illustrates a case in which the current does not flow to the sub-pixel electrode 120 when the control circuit 160 is in an OFF state. In this case, since a magnetic field is not applied to the magnetic material layer 130, the magnetic moments in the magnetic material layer 130 are randomly oriented. Thus, as described above, the light incident on the magnetic material layer 130 is all reflected. As shown in FIG. 15, lights A and B, emitted from a backlight unit (not shown) and incident on the magnetic material layer 130 through the first transparent substrate 110, are all reflected from the magnetic material layer 130. Also, external lights A′ and B′, incident on the magnetic material layer 130 through the front transparent substrate 150, are all reflected from the magnetic material layer 130.

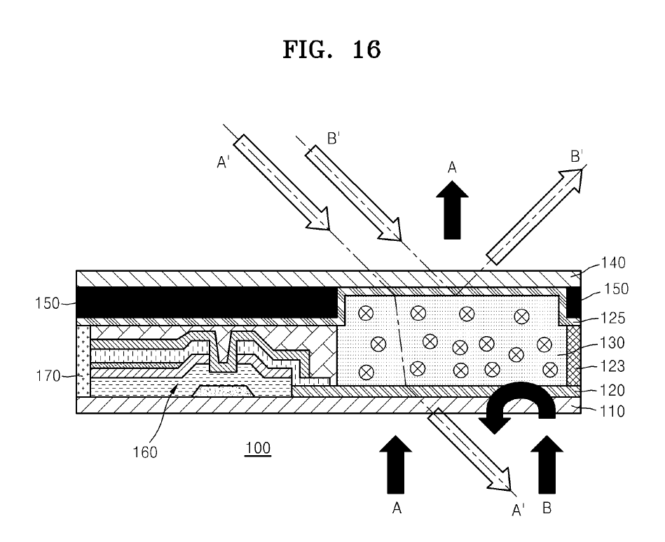

FIG. 16 illustrates a case in which the control circuit 160 is in an ON state so that a current flows into the sub-pixel electrode 120. In this case, since the magnetic field is applied to the magnetic material layer 130 through the sub-pixel electrode 120, the magnetic moments in the magnetic material layer 130 are all oriented in one direction. Thus, as described above, the light of a polarization component related to a magnetic field component parallel to the magnetization direction of the magnetic material layer 130 (hereinafter, referred to as the light of a parallel polarization component) is reflected from the magnetic material layer 130. The light of a polarization component related to a magnetic field component perpendicular to the magnetization direction (hereinafter, referred to as the light of a perpendicular polarization component) passes through the magnetic material layer 130.

For example, as shown in FIG. 16, of the light emitted from the backlight unit and incident on the magnetic material layer 130 through the first transparent substrate 110, a light A of a perpendicular polarization component passes through the magnetic material layer 130 and contributes to the formation of an image. Meanwhile, a light B of a parallel polarization component is reflected from the magnetic material layer 130. The light B of a parallel polarization component is reflected by, for example, a mirror (not shown) provided under the backlight unit, and then changed to a light in a unpolarized state using a diffusion plate (not shown). Thus, the reflected light of a parallel polarization component can be reused through the above-described step.

Also, of the external light incident on the magnetic material layer 130 through the front transparent substrate 150, a light A′ of a perpendicular polarization component passes through the magnetic material layer 130. As already described with reference to FIG. 1, when a semi-transmission mirror is formed on at least one of the optical surfaces from the magnetic material layer 130 to the rear transparent substrate 110, the external light A′ of a perpendicular polarization component is reflected again to be used for the formation of an image. In contrast, a light B′ of a parallel polarization component incident on the magnetic material layer 130 through the front transparent substrate 150 is reflected from the surface of the magnetic material layer 130. The reflected light B′ does not contribute to the formation of an image and may tire the eyes of a viewer. To address this problem, an absorptive polarization panel to absorb only the light B′ of a parallel polarization component or an antireflection coating can be formed on any of the optical surfaces from the magnetic material layer 130 to the front transparent substrate 150.

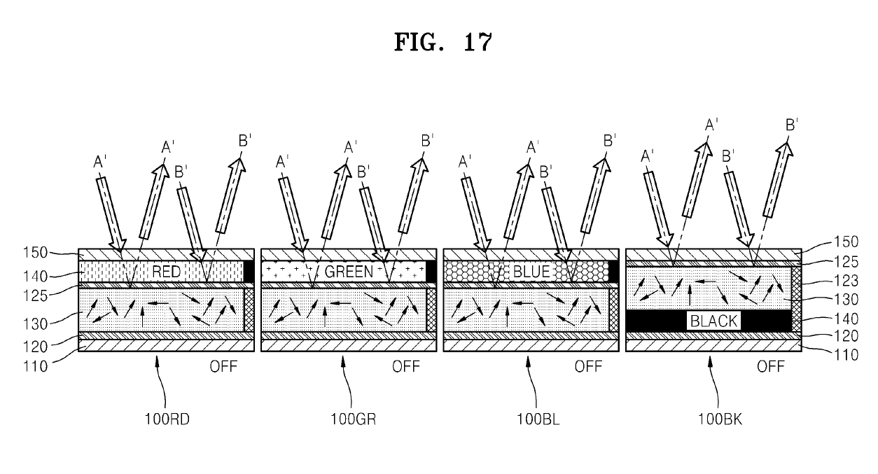

When the operation of the sub-pixel 100 is used, a particular color can be represented at a pixel of the color magnetic display panel according to the present invention. Referring to FIG. 17, a pixel of the color magnetic display panel according to the present invention is formed of four sub-pixels 100RD, 100GR, 100BL, and 100BK having red, green, blue, and block color filters. For a conventional display panel like the LCD panel, a pixel is generally formed of red, green, and blue sub-pixels and a black color is implemented by blocking or absorbing light. However, for the color magnetic display panel according to the present invention, since the magnetic material layer 130 functioning as an optical shutter reflects or transmits light, not absorbs light, an additional sub-pixel having a black filter is needed. In the sub-pixel 100BK having a black filter, the light reflected from the magnetic material layer 130 may not pass through the black filter. Thus, as shown in FIG. 17, in the sub-pixel 100BK having the black filter, the color filter 140 is preferably, but not necessarily, located under the magnetic material layer 130. Although FIG. 17 illustrates that the color filter 140 is arranged between the magnetic material layer 130 and the sub-pixel electrode 120 in the sub-pixel 100BK having the black filter, the color filter 140 can be arranged between the sub-pixel electrode 120 and the rear transparent substrate 110. The color filter of the black sub-pixel 100BK can be formed of, for example, a material absorbing light like a black matrix.

Referring to FIGS. 17-25, the operation to implement a desired color from a pixel of the color magnetic display panel according to the present invention formed of four sub-pixels 100RD, 100GR, 100BL, and 100BK respectively having red, green, blue, and black color filters is described. The control circuit 160 is not shown in the sub-pixels illustrated in FIGS. 17-25.

FIG. 17 illustrates a case in which the four sub-pixels 100RD, 100GR, 100BL, and 100BK are all in an OFF state. In this case, all lights incident on the color magnetic display panel are reflected from the magnetic material layer 130 of each sub-pixel 100. As described above, for the sub-pixels 100RD, 100GR, and 100BL respectively having red, green, and blue color filters, each color filter 130 is arranged between the front transparent substrate 150 and the magnetic material layer 130. Thus, the light reflected from the magnetic material layer 130 of the sub-pixels 100RD, 100GR, and 100BL respectively having red, green, and blue color filters has a particular color by the respective color filters of the sub-pixels 100RD, 100GR, and 100BL. For example, the light reflected from the magnetic material layer 130 of the red sub-pixel 100RD is red. The light reflected from the magnetic material layer 130 of the green sub-pixel 100GR is green. The light reflected from the magnetic material layer 130 of the blue sub-pixel 100BL is blue. Thus, when the four sub-pixels 100RD, 100GR, and 100BL are all in the OFF state, a pixel of the color magnetic display panel according to the present invention appears to be white as a whole.

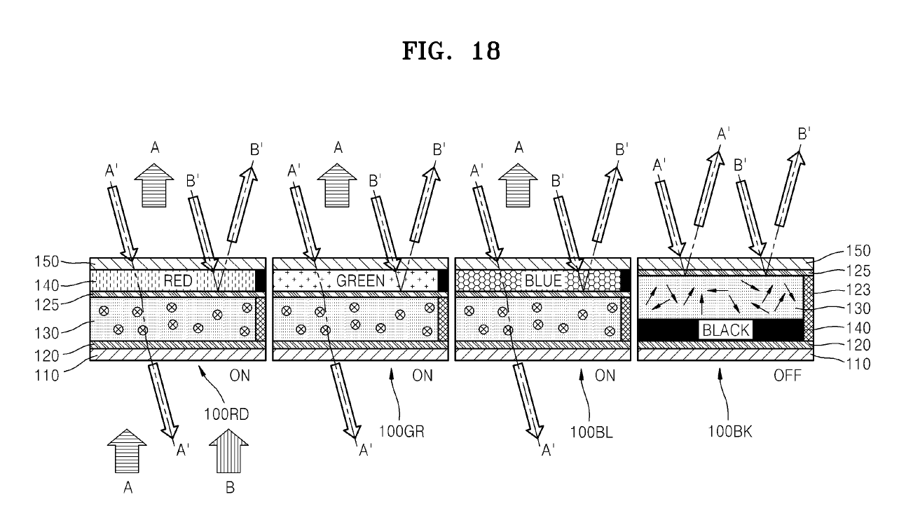

FIG. 18 illustrates a case in which the red, green, and blue sub-pixels 100RD, 100GR, and 100BL are all in the ON state and only the black sub-pixel 100BK is in the OFF state. In this case, of the external lights A′ and B′ incident on the red, green, and blue sub-pixels 100RD, 100GR, and 100BL, the external light A′ of a perpendicular polarization component passes through the magnetic material layer 130, but the external light B′ of a parallel polarization component is reflected from the magnetic material layer 130. As described above, the reflected external light B′ can be removed using the antireflection coating or absorptive polarizer. Also, of the lights A and B emitted from the backlight unit and incident on the red, green, and blue sub-pixels 100RD, 100GR, and 100BL, the light A of a perpendicular polarization component passed through the magnetic material layer 130, but the light B of a parallel polarization component is reflected from the magnetic material layer 130.

Thus, only the light A of a perpendicular polarization component emitted from the backlight unit has a color by passing through the magnetic material layer 130 and the color filter 140 of each of the red, green, and blue sub-pixels 100RD, 100GR, and 100BL. In contrast, the external lights A′ and B′ and the lights A and B emitted from the backlight unit which are incident on the black sub-pixel 100BK are all reflected from the magnetic material layer 130. As a result, when the red, green, and blue sub-pixels 100RD, 100GR, and 100BL are in the ON state and the black sub-pixel 100BK is in the OFF state, the pixel of the color magnetic display panel according to the present invention appears to be white as a whole. Compared to the case of FIG. 17, in the case of FIG. 18, since white color is formed using the light A emitted from the backlight unit, a much brighter white color can be obtained.

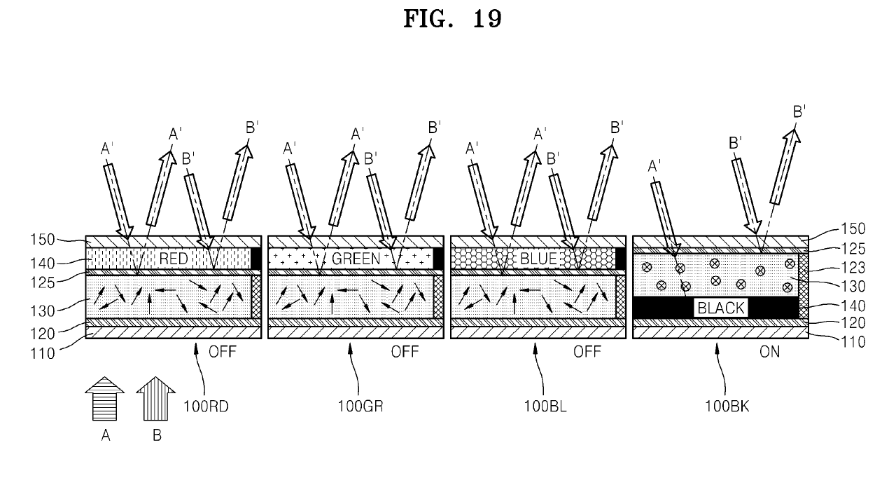

FIG. 19 illustrates a case in which the red, green, and blue sub-pixels 100RD, 100GR, and 100BL are all in the OFF state and only the black sub-pixel 100BK is in the ON state. In this case, the external lights A′ and B′ incident on the red, green, and blue sub-pixels 100RD, 100GR, and 100BL are reflected from the magnetic material layer 130. Of the external lights A′ and B′ incident on the black sub-pixel 100BK, the external light A′ of a perpendicular polarization component passes through the magnetic material layer 130 of the black sub-pixel 100BK and absorbed by the color filter 140. However, the external light B′ of a parallel polarization component is reflected by the surface of the magnetic material layer 130.

The lights A and B emitted from the backlight unit and incident on the red, green, and blue sub-pixels 100RD, 100GR, and 100BL are all reflected from the magnetic material layer 130. The lights A and B emitted from the backlight unit and incident on the black sub-pixel 100BK are absorbed by the color filter 140.

In this case, since the reflected external lights A′ and B′ pass through the color filter 130 of each of the red, green, and blue sub-pixels 100RD, 100GR, and 100BL, the lights appear slight white. Since the lights are absorbed in the black sub-pixel 100BK, the lights appear as strong black. As a result, the background of light white is tinged with strong black as a whole so that a pixel of the color magnetic display panel according to the present invention appears black as a whole. Accordingly, the color magnetic display panel according to the present invention can represent black without the backlight unit even if only an external light exists.

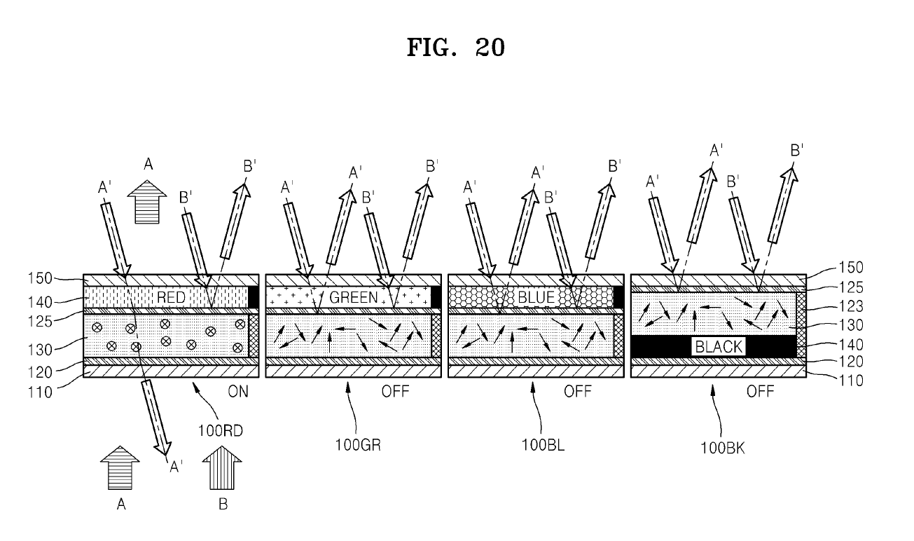

FIG. 20. illustrates a case in which the green, blue, and black sub-pixels 100GR, 100BL, and 100BK are all in OFF state and the red sub-pixel 100RD is in an ON state. In this case, the external lights A′ and B′ incident on the green, blue, and black sub-pixels 100GR, 100BL, and 100BK are all reflected from the magnetic material layer 130. Of the external light A′ and B′ incident on the red sub-pixel 100RD, the external light A′ of a perpendicular polarization component passes through the magnetic material layer 130 of the red sub-pixel 100RD and the external light B′ of a parallel polarization component is reflected from the surface of the magnetic material layer 130.

Also, the lights A and B emitted from the backlight unit and incident on the green and blue sub-pixels 100GR and 100BL are all reflected from the magnetic material layer 130 and the lights A and B incident on the black sub-pixel 100BK are all absorbed by the color filter 140. Of the lights A and B emitted from the backlight unit and incident on the red sub-pixel 100RD, the light A of a perpendicular polarization component passes through the magnetic material layer 130 of the red sub-pixel 100RD and the light B of a parallel polarization component is reflected from the magnetic material layer 130.

In this case, the reflected external lights A′ and B′ passing through the color filter 140 of each of the red, green, and blue sub-pixels 100RD, 100GR, and 100BL appears to be light white. However, the external light A′ of a perpendicular polarization component of the external lights A′ and B′ incident on the red sub-pixel 100RD passes through the magnetic material layer 130, thus not contributing to the formation of a white color. The light A of a perpendicular polarization component emitted from the backlight unit passes through the color filter 140 of the red sub-pixel 100RD and appears as strong red. Thus, since the background of light white is tinged with strong red as a whole, the pixel of the color magnetic display panel according to the present invention appears to be red as a whole.

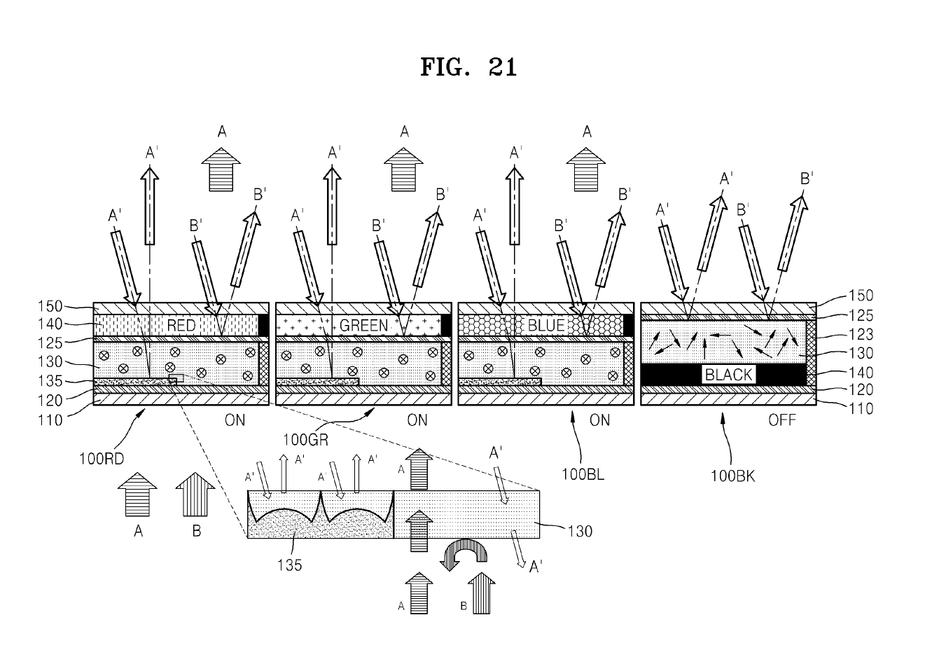

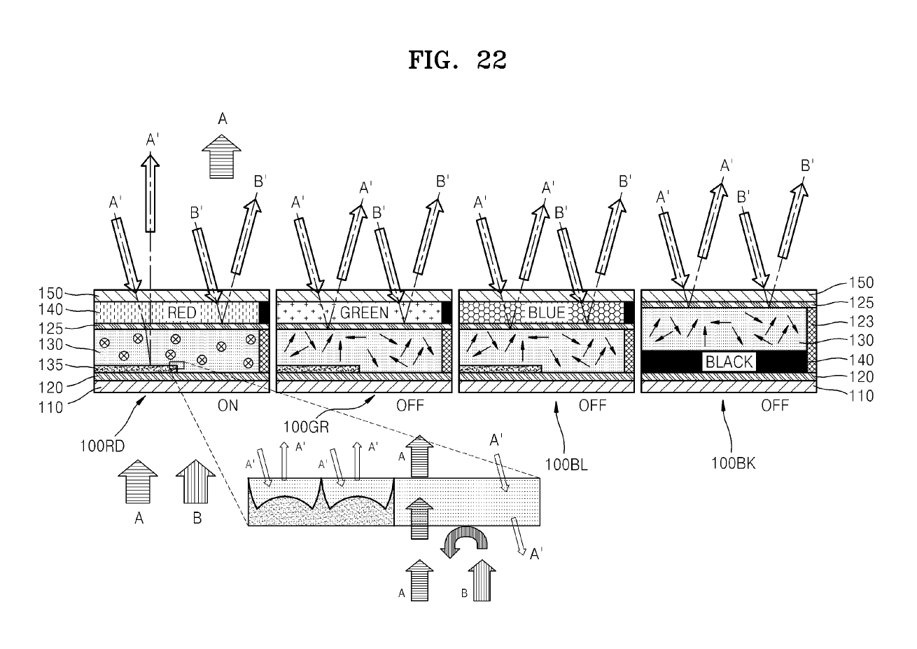

In the exemplary embodiments shown in FIGS. 18-20, the external light is wasted because the external light A′ of a perpendicular polarization component of the external lights A′ and B′ passes through the magnetic material layer 130 of the sub-pixel in the ON state. In the exemplary embodiments shown in FIGS. 21 and 22, a reflection plate 135 for reflecting the external light A′ of a perpendicular polarization component to reuse is further arranged in a part of the lower portion of the magnetic material layer 130. In particular, referring to an enlarged portion in each of FIGS. 21 and 22, the reflection plate 135 can be formed of an array of hybrid curved surfaces combined with two types of curved surfaces. For example, the center portion of the hybrid curved surface of the reflection plate 135 can be a convex parabolic surface having a symmetry axis at the center thereof. The outer circumferential portion surrounding the center portion of the reflection plate 135 is a concave, curved surface having a focus at the symmetry axis of the center portion and a concave parabolic surface extending from the center portion. A plan view of such a reflection plate 135 is shown in FIG. 28. Accordingly, most of the external light A′ reflected by the reflection plate 135 travels in a direction perpendicular to the surface of the color magnetic display panel.

FIG. 21 illustrates a case in which the red, green, and blue sub-pixels 100RD, 100GR, and 100BL are all in the ON state and the black sub-pixel 100BK is in the OFF state as shown in FIG. 18. In this case, as described with reference to FIG. 18, a pixel of the color magnetic display panel according to the present invention appears to be white. Compared to the case of FIG. 18, in the case of FIG. 21, since the white color is formed using the external light A′ reflected from the reflection plate 135 of each of the red, green, and blue sub-pixels 100RD, 100GR, and 100BL with the light A emitted from the backlight unit, a much brighter white color can be obtained. In particular, since the external light A′ reflected from the reflection plate 135 is reflected in a direction almost perpendicular to the surface of the color magnetic display panel, most of the external light A′ can be provided to a viewer located in front of the color magnetic display panel. Thus, compared to the case in which the external light is reflected at the same angle as an incident angle, more improved brightness can be obtained.

FIG. 22 illustrates a case in which the green, blue, and black sub-pixels 100GR, 100BL, and 100BK are all in the OFF state and the red sub-pixel 100RD is in the ON state as shown in FIG. 20. In this case, as described with reference to FIG. 20, a pixel of the color magnetic display panel according to the present invention appears to be red. Compared to the case of FIG. 20, in the case of FIG. 22, since the red color is formed using the external light A′ reflected from the reflection plate 135 of the red sub-pixel 100RD with the light A emitted from the backlight unit, a much brighter red color can be obtained.

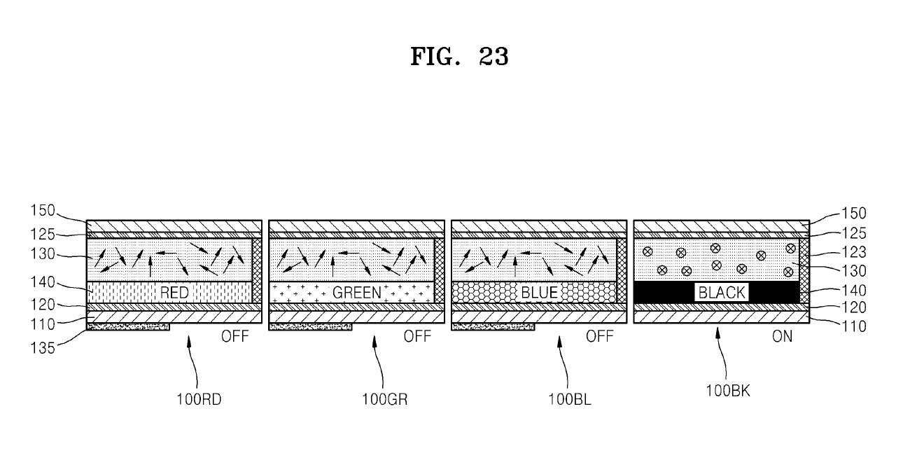

FIGS. 23-25 illustrate a case in which the color filter 140 of each of the red, green, and blue sub-pixels 100RD, 100GR, and 100BL is located under the magnetic material layer 130 like the color filter 140 of the black sub-pixel 100BK. Although in FIGS. 23-25 the color filter 140 is arranged between the sub-pixel electrode 120 and the magnetic material layer 130 of each of the red, green, blue, and black sub-pixels 100RD, 100GR, 100BL, and 100BK, the color filter 140 can be arranged between the sub-pixel electrode 120 and the rear transparent substrate 110. Also, although in FIGS. 23-25 the reflection plate 135 is arranged under the rear transparent substrate 110 of the red, green, and blue sub-pixels 100RD, 100GR, and 100BL, the reflection plate 135 can be arranged under each color filter 140. However, the reflection plate 135 may not be arranged in the black sub-pixel 100BK.

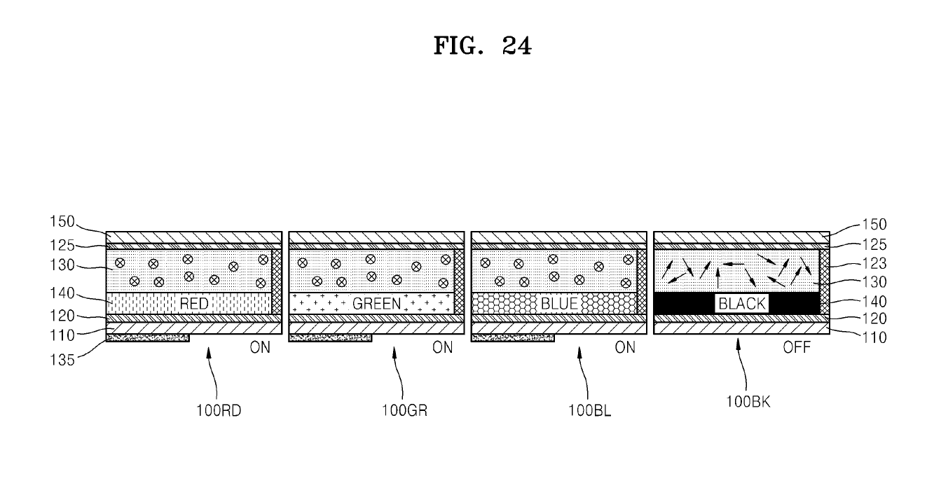

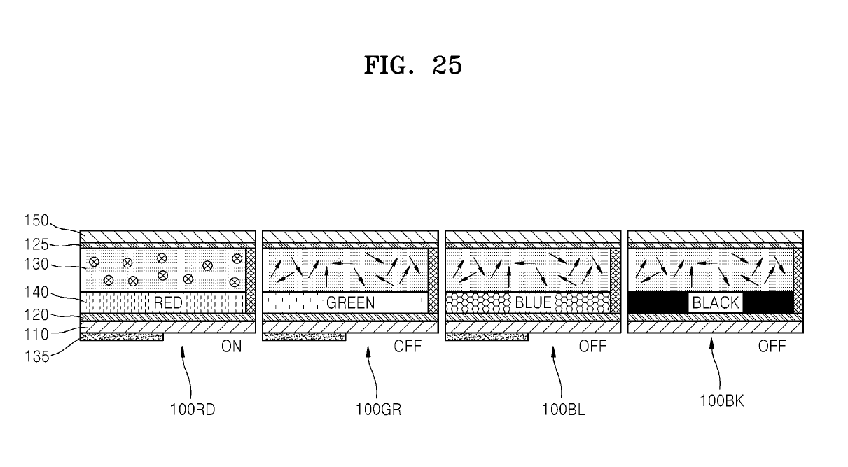

In the exemplary embodiments of FIGS. 17-22, white always exists as a background color. However, in the present exemplary embodiments of FIGS. 23-25, when all sub-pixels 100RD, 100GR, 100BL, and 100BK are in the OFF state, the color magnetic display panel according to the present invention appears to be a mirror. Thus, to represent black, as shown in FIG. 23, the black sub-pixel 100BK is in the ON state and the other sub-pixels 100RD, 100GR, and 100BL are in the OFF state. Also, to represent white color, as shown in FIG. 24, the black sub-pixel 100BK is in the OFF state and the other sub-pixels 100RD, 100GR, and 100BL are in the ON state. To represent red, as shown in FIG. 25, the red sub-pixel 100RD is in the ON state and the other sub-pixels 100GR, 100BL, and 100BK are in the OFF state.

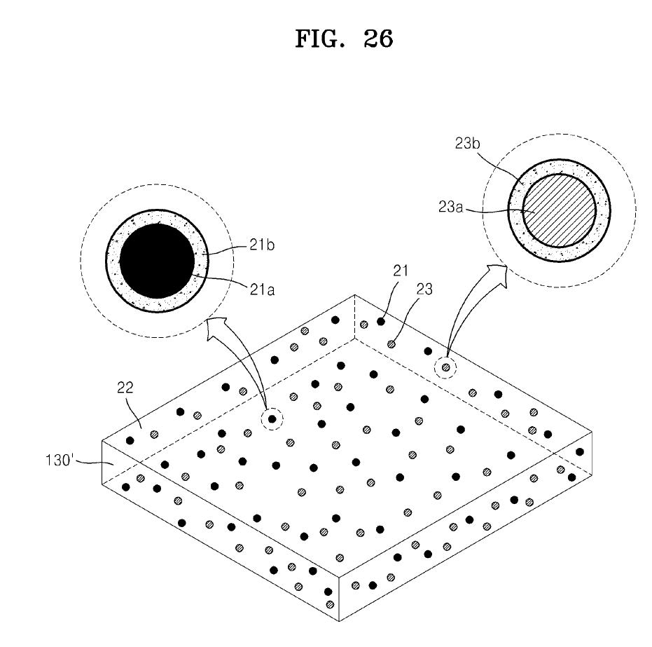

In the color magnetic display panels according to the exemplary embodiments of the present invention, the magnetic material layer 130 and the color filter 140 exist in separate layers. However, according to another exemplary embodiment of the present invention, the magnetic material layer can simultaneously perform the function of a color filter. FIG. 26 illustrates the structure of a magnetic material layer 130′ according to another exemplary embodiment of the present invention.

Referring to FIG. 26, the magnetic material layer 130′ has a structure that a plurality of magnetic particles 21 and a plurality of color absorbing particles 23 are distributed in a transparent insulation medium 22. In FIG. 26, for convenience of explanation, the magnetic particles 21 and the color absorbing particles 23 are sparsely distributed in the magnetic material layer 130′. However, in an exemplary embodiment, the magnetic particles 21 and the color absorbing particles 23 fill the magnetic material layer 130′ very densely, i.e., are densely distributed. The magnetic particles 21 formed of a magnetic core having the same structure as one described above. That is, as shown in an enlarged portion of FIG. 26, each of the magnetic particles 21 has a core-shell structure formed of a magnetic core 21a having a transparent insulation shell 21b encompassing the magnetic core 21a.

The color absorption particles 23 also have the core-shell structure as shown in an enlarge portion of FIG. 26. However, it is a difference that the core-shell structure of the color absorption particles 23 is formed of a core 23a formed of a dielectric and a shell 23b formed of a metal material. For example, gold, silver, or aluminum is mainly used for the shell 23b of the color absorption particulars 23 and SiO₂ is mainly used for the core 23a of the color absorption particles 23. The color absorption particles 23 of the core-shell structure are widely used for a filter to absorb a wavelength of a particular wavelength band. When light is incident on a thin metal film formed on a dielectric, a surface plasmon resonance is generated on a boundary surface between the dielectric and the metal film so that light of a particular wavelength band is absorbed. The resonance wavelength is not related to the size of the core-shell structure and determined by a ratio of radii of the core 23a and the shell 23b. However, to generate the surface plasmon resonance, it is appropriate that the diameter of each color absorption particle 23 is not more than about 50 nm.

FIG. 26 illustrates that the same sort of the color absorption particles 23 are distributed in the magnetic material layer 130′. However, a variety of sorts of the color absorption particles 23 are mixed and distributed. For example, to implement green, color absorption particles absorbing light of a red wavelength band and color absorption particles absorbing light of a blue wavelength band are mixed and distributed in the magnetic material layer 130′. Also, to implement red, color absorption particles absorbing light of a green wavelength band and color absorption particles absorbing light of a blue wavelength band are mixed in the magnetic material layer 130′. Thus, the color absorption particles having various ratios of the radii of the core 23a and the shell 23b can be distributed in the magnetic material layer 130′.

Also, the color absorption particles 23 do not need to be a ball type and may have a nanorod shape. Even when the color absorption particles 23 have a nanorod shape, the color absorption particles 23 can absorb light of a particular wavelength band by the surface plasmon resonance. In this case, the resonance wavelength is determined by the aspect ratio of the nanorod. Thus, to implement a desired color, the color absorption particles 23 of a nanorod shape having various aspect ratios and the color absorption particles 23 of a ball shape having various ratios of the radii of the core and the shell can be mixed and distributed in the magnetic material layer 130′.

The magnetic material layer 130′ can be formed by, for example, immersing a mixture of the magnetic particles 21 of a core-shell structure and the color absorption particles 23 in a solution and performing spin coating or deep coating of the solution thinly on the sub-pixel electrode 120, and then, curing the coated mixture. In addition, a variety of methods can be employed only if the magnetic particles 21 can exist in the magnetic material layer 130′ without being agglomerated together or electrically contacting one another. Preferably, but not necessarily, the size of each of the color absorption particles 23 is smaller than or similar to that of each of the magnetic particles 21. When the size of each of the color absorption particles 23 is excessively larger than that of each of the magnetic particles 21, the polarization separation function of the magnetic particles 21 can be degraded.

The distribution of the color absorption particles 23 in the magnetic material layer 130′ is to enable the magnetic material layer 130′ to perform the function of a color filter at the same time. Accordingly, the magnetic material layer 130′ can be differently embodied only if the function of the magnetic particles 21 is not affected and simultaneously the function of a color filter is performed. For example, the magnetic particles 21 of the core-shell structure is distributed in a medium for a color filter in a liquid or paste state, and then cured, so as to form the magnetic material layer 130′. Also, after the magnetic particles 21 of the core-shell structure are immersed into a solution with a pigment for a color filter, the solution is thinly coated on the sub-pixel electrode 120 so that the magnetic material layer 130′ can be formed.

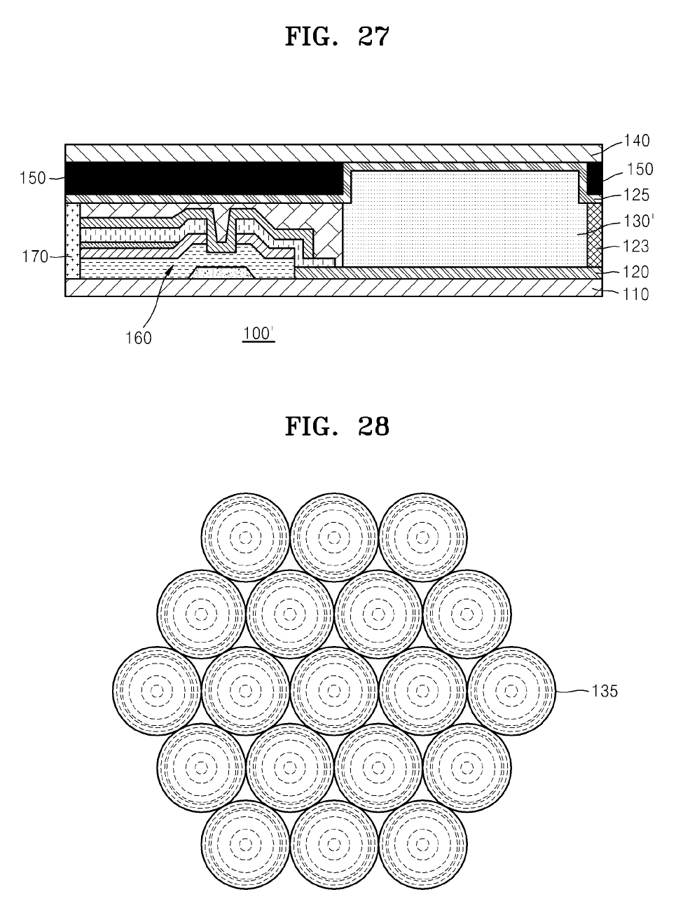

FIG. 27 illustrates the structure of a sub-pixel 100′ of a color magnetic display panel according to another exemplary embodiment of the present invention using the above-described magnetic material layer 130′ that performs the function of a color filter at the same time. Compared to the sub-pixel 100 of FIG. 1, the sub-pixel 100′ of FIG. 27 has a difference in that the color filter 140 is omitted and the magnetic material layer 130′ has a color filter function.

When a desired color is implemented in a pixel including the sub-pixels 100′ of FIG. 27, the magnetic display panel is operated according to the method described with reference to FIGS. 23-25. That is, when all sub-pixels are in the OFF state, the color magnetic display panel appears to be a mirror. To represent black color, the black sub-pixel is in the ON state and the other sub-pixels are in the OFF state. Also, to represent white, the black sub-pixel is in the OFF state and the other sub-pixels are in the ON state. To represent red, the red sub-pixel is in the ON state and the other sub-pixels are in the OFF state.

As described above, according to the color magnetic display panel according to the present invention, an optical shutter adjusting transmission/blocking of light can be embodied with a smaller number of parts than the conventional LCD panel. Thus, a color display panel capable of representing a desired color simply and at low costs compared to the conventional LCD panel.

Also, the color magnetic display panel according to the present invention can be fabricated using most of the manufacturing process for the conventional LCD panel, and thus the present manufacturing line for the LCD panel can be used as it is.

The color magnetic display panel according to the present invention can be manufactured not only in a small size but also in a large size. Thus, the color magnetic display panel according to the present invention can be widely used for electronic devices having various sizes such as TVs, PCs, notebooks, mobile phones, PMPs, and game consoles.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A display panel including a pixel comprising red, green, blue and black sub-pixels, wherein each of the sub-pixels comprises:
a magnetic material layer including magnetic moments;
a first electrode which generates a magnetic field that is received at the magnetic material layer;
a second electrode electrically connected to the first electrode; and
a control circuit which controls a flow of current between the first electrode and the second electrode.

2. The display panel of claim 1, wherein a light of a magnetic field component parallel to a direction in which the magnetic moments in the magnetic material layer are oriented, is reflected at the magnetic material layer, and a light of a magnetic field component perpendicular to the direction, passes through the magnetic material layer.

3. The display panel of claim 1, wherein a thickness of the magnetic material layer is greater than a magnetic decay length of the magnetic material layer.

4. The display panel of claim 3, wherein the magnetic material layer comprises:
a transparent insulation medium; and
a plurality of magnetic particles distributed in the transparent insulation medium, each of the plurality of magnetic particles including a magnetic core having a transparent insulation shell encompassing the magnetic core.

5. The display panel of claim 4, wherein one magnetic core forms a single magnetic domain.

6. The display panel of claim 4, wherein the magnetic core is formed of one of a ferromagnetic material, a paramagnetic material and a superparamagnetic material.

7. The display panel of claim 6, wherein the magnetic core is formed of one of materials selected from a group consisting of cobalt, iron, iron oxide, nickel, a Co—Pt alloy, a Fe—Pt alloy, titanium, aluminum, barium, platinum, sodium, strontium, magnesium, dysprosium, manganese, and gadolinium, silver, copper, and chromium, or an alloy comprising at least two materials of the group.

8. The display panel of claim 3, wherein the magnetic material layer is formed of a magnetic polymer film having conductivity.

9. The display panel of claim 1, wherein the sub-pixel further comprises a conductive spacer which is disposed at a side surface of the magnetic material layer and electrically connects the first electrode and the second electrode.

10. The display panel of claim 9, wherein the second electrode is a flat sheet or a lattice type wire electrically connected to the conductive spacer.

11. The display panel of claim 9, wherein the first electrode, the second electrode, and the conductive spacer are formed of any of materials selected from a group consisting of aluminum, copper, silver, platinum, gold, barium, sodium, strontium, magnesium, and iodine-doped polyacetylene.

12. The display panel of claim 11, wherein a first hole is formed in an area of the first electrode facing the magnetic material layer and a plurality of wires extending in a direction in which current flows, are formed in the first hole to allow light to pass through the first electrode.

13. The display panel of claim 11, wherein a second hole is formed in an area of the second electrode facing the magnetic material layer to allow light to pass through the second electrode.

14. The display panel of claim 1, wherein the first electrode and the second electrode are formed of a transparent conductive material.

15. The display panel of claim 1, wherein the sub-pixel further comprises one of a red filter, a green filter, and a blue filter disposed above or under the magnetic material layer, or a black filter disposed under the magnetic material layer.

16. The display panel of claim 15, wherein the sub-pixel further comprises a rear transparent substrate and a front transparent substrate respectively disposed at a rear surface and a front surface of the display panel to encompass the rear and the front surfaces of the sub-pixel.

17. The display panel of claim 16, wherein the sub-pixel further comprises an absorption polarizer disposed at any one of optical surfaces from the magnetic material layer to an external surface of the front transparent substrate.

18. The display panel of claim 16, wherein each of the sub-pixels further comprises an antireflection coating disposed at least one of optical surfaces from the magnetic material layer to an external surface of the front transparent substrate.

19. The display panel of claim 16, wherein the rear transparent substrate, the front transparent substrate, and the second electrode are shared by a plurality of pixels and the magnetic material layer, the first electrode, the color filter, and the control circuit are respectively provided for each of sub-pixels of the plurality of pixels.

20. The display panel of claim 16, wherein the sub-pixel further comprises a reflection plate disposed at least one of optical surfaces from the lower portion of the color filter to an external surface of the rear transparent substrate.

21. The display panel of claim 20, wherein the reflection plate comprises an array of hybrid curved surfaces, a center portion of one of the hybrid curved surfaces is a convex parabolic surface having a symmetry axis at a center thereof, and an outer circumferential portion surrounding the center portion of the hybrid curved surface is a concave parabolic surface extending from the center portion and having a focus at a symmetry axis of the center portion.

22. The display panel of claim 1, wherein pigments or color absorption particles are mixed in the magnetic material layer.

23. The display panel of claim 22, wherein each of the color absorption particles is formed of a core formed of a dielectric and a shell formed of metal.
